(19) United States
(12) Patent Application Publication
(10) Pub. No.: US 2011/0007033 A1
(43) Pub. Date: Jan. 13, 2011

(54) LIQUID CRYSTAL DISPLAY

(76) Inventor: Ikchang Choi, Chilgok-gun (KR)

Correspondence Address: BIRCH STEWART KOLASCH & BIRCH, PO BOX 747, FALLS CHURCH, VA, 22040-0747, US

(21) Appl. No.: 12/791,772

(22) Filed: Jun. 1, 2010

(30) Foreign Application Priority Data
Jul. 7, 2009 (KR) 10-2009-0061678

(51) Int. Cl. G06F 3/042

(52) U.S. Cl. 345/175

(57) ABSTRACT

According to an embodiment, a liquid crystal display comprises a backlight unit, a liquid crystal panel assembly placed on the backlight unit, a reflector frame placed in the periphery of the liquid crystal panel assembly and including a reflector, a top case coupling the backlight unit, the liquid crystal panel assembly, and the reflector frame, to each other, and an optical sensor camera placed in at least one corner of the top case.

This application claims the priority and the benefit of Korean Patent Application No. 10-2009-0061678 filed on Jul. 7, 2009 which is hereby incorporated by reference.

### BACKGROUND

1. Field

This document relates to a liquid crystal display, and more particularly, to a liquid crystal display capable of implementing a touch function by including an optical sensor camera, and of reducing its manufacturing cost and weight.

2. Related Art

In recent years, the society has entered a full-blown information age, and thereby display fields have been widely developed which visually represent various kinds of electrical signal information. Further, various flat panel display devices (FPDs), with good characteristics such as slim, light-weight, low power consumption or the like, have been introduced and have come into the spotlight as substitutes for an existing cathode ray tube (CRT).

Such FPDs include, for example, liquid crystal displays (LCDs), plasma display panels (PDPs), field emission displays (FEDs), electroluminescence displays (ELDs) and so on. Among these, the LCDs have a large contrast ratio and are excellent in displaying moving pictures, and hence nowadays are widely employed in display screens for notebooks, monitors, and TV set fields.

The LCD is a non-emitting device utilizing a backlight unit placed in a lower part of an LC panel assembly, and is a display device realizing a full color display while light from the backlight unit passes through the LC panel assembly.

Recently, there has appeared an LCD having a touch function which is one of many interfaces between information communication devices using various kinds of display devices and a user, and enables desired information to be input to the devices by the user directly touching their screens with a finger or a stylus.

Therefore, a study on the LCD having the touch function is being actively progressed so as to practically put to use such an LCD and reduce its manufacturing cost and weight for commercial use.

### SUMMARY

Embodiments of the present invention provide a liquid crystal display and its method capable of implementing a touch function by including an optical sensor camera, and of reducing its manufacturing cost and weight.

According to an exemplary embodiment of the present invention, there is provided a liquid crystal display comprising a backlight unit, a liquid crystal panel assembly placed on the backlight unit, a reflector frame placed in the periphery of the liquid crystal panel assembly and including a reflector, a top case coupling the backlight unit, the liquid crystal panel assembly, and the reflector frame to each other, and an optical sensor camera placed in at least one corner of the top case.

### BRIEF DESCRIPTION OF THE DRAWINGS

The accompany drawings, which are included to provide a further understanding of the invention and are incorporated on and constitute a part of this specification illustrate embodiments of the invention and together with the description serve to explain the principles of the invention.

FIG. 1 is an exploded view of a liquid crystal display according to an embodiment of the invention;

FIG. 2 is a sectional view taken along the line I-I′ in FIG. 1;

FIG. 3 is a perspective view of the liquid crystal display according to an embodiment of the invention;

FIG. 4 is a diagram illustrating an optical sensor cameral according to an embodiment of the invention;

FIG. 5 is a flowchart illustrating control steps in a touch recognition algorithm according to an embodiment of the invention; and

FIG. 6 is a schematic diagram illustrating a triangulation method according to an embodiment of the invention.

### DETAILED DESCRIPTION

Reference will now be made in detail embodiments of the invention examples of which are illustrated in the accompanying drawings.

A liquid crystal display (“LCD”) according to an embodiment of the invention comprises a backlight unit, a liquid crystal panel assembly placed on the backlight unit, a reflector frame placed in the periphery of the liquid crystal panel assembly and including a reflector, a top case coupling the backlight unit, the liquid crystal panel assembly, and the reflector frame to each other, and an optical sensor camera placed in at least one corner of the top case.

Here, the reflector frame may be divided in plurality to be spaced apart from each other and respectively placed in four edges of the liquid crystal panel assembly.

The reflector may be placed at surfaces where the reflector frames face each other.

The reflector frame and optical sensor camera may be placed between the liquid crystal panel assembly and the top case.

The reflector frame and the optical sensor camera may be placed in the inner side of the top case.

The optical sensor camera and the reflector frame may be placed on the same plane.

The optical sensor camera is equal to or more than one.

The optical sensor camera may comprise an infrared irradiation unit and an infrared incident unit.

The lens angle of view of the optical sensor camera may range from about 80° to about 90°.

Hereinafter, an implementation of the embodiment(s) of the invention will be described in detail with reference to the attached drawings.

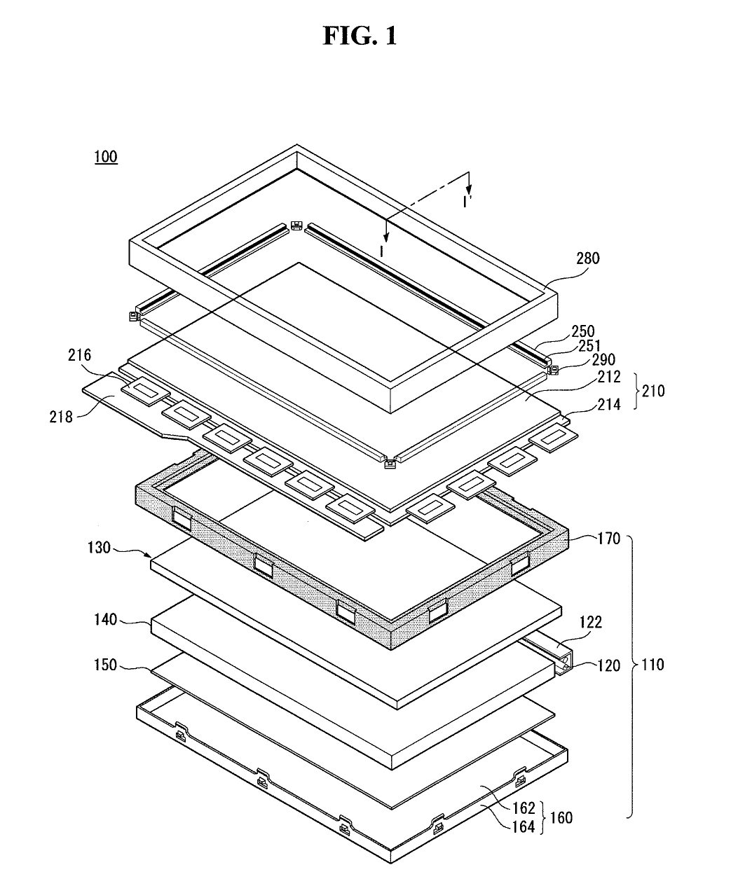

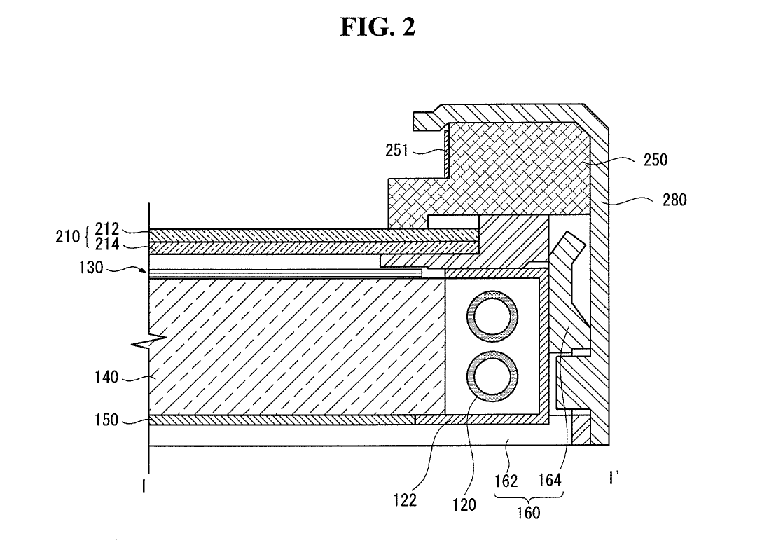

FIG. 1 is an exploded view of a liquid crystal display according to an embodiment of the invention, and FIG. 2 is a sectional view taken along the line I-I′ in FIG. 1.

Referring to FIGS. 1 and 2, an LCD 100 according to an embodiment of the invention includes a backlight unit 110, an LC panel assembly 210 placed on the backlight unit 210, a reflector frame 250 placed in the periphery of the LC panel assembly 210 and having reflectors 251, a top case 280 coupling the backlight unit 110, the LC panel assembly 210, and the reflector frames 250, to each other, and an optical sensor camera 290 placed in a corner of the top case 280.

The backlight unit 110 is installed in the lower part of the LC panel assembly 210 and provides light for the LC panel assembly 210.

The backlight unit 110 has a light source 120 and an optical sheet 130.

For the light source 120, at least one light source may be disposed in one side of a light guide plate 140 along the long axial direction of the light guide plate 140, or at least one light source may be disposed in each side of the light guide plate 140. Here, light emitted from the light source 120 is directly incident to the light guide plate 140 or the light guide plate 140 after being reflected from a light source housing 122 formed to surround a portion of the light source 120, for example, about ¾ of the outer circumference of the light source 120.

Specifically, the light source 120 may include, but not limited to, any one of a cold cathode fluorescent lamp (CCFL), a hot cathode fluorescent lamp (HCFL), an external electrode fluorescent lamp (EEFL) and a light emitting diode (LED).

The optical sheet 130 is disposed on the light guide plate 140. The optical sheet 130 concentrates or diffuses light emitted from the light source 120.

The backlight unit backlight unit 110 further have a reflector 150, a bottom cover 160, and a mold frame 170.

The light guide plate 140 is disposed to face the light source 120, and guides light from the light source 120 upward.

The reflector 150 is placed under the light guide plate 140 to upwardly reflect some of light beams emitted from the light source 120, which travel toward the reflector 150 via the light guide plate 140.

The bottom cover 160 includes a bottom 162 and a side section 164 extending upwards from the bottom 162 to form a housing space, and the housing space house the light source 120, the optical sheet 130, the light guide plate 140, and the reflector 150.

The mold frame 170 is substantially tetragonal, and is coupled to the bottom cover 160 from the upper side of the bottom cover 160 in the top down manner.

The LC panel assembly 210 is contained in the mold frame 170, and is fixed by the top cover 280 which is coupled to the bottom cover 160 in the top down manner.

The LC panel assembly 210 display images using the light provided from the backlight unit 110, specifically, the light emitted from the light source 120.

An LC mode in the LC panel assembly 210 may employ not only a TN (Twisted Nematic) mode, a VA (Vertical Alignment) mode, an IPS (In Plane Switching) mode, an FFS (Fringe Field Switching) mode but also any other mode. In addition, the LC panel assembly 210 may be implemented by any types such as a transmissive LCD, a transflective LCD, a reflective LCD or the like.

The LC panel assembly 210 includes a color filter panel 212 and a thin film transistor (TFT) panel 214 opposite to each other, with an LC layer between the color filter panel 212 and the TFT panel 214.

The color filter panel 212 implements colors of the images displayed on the LC panel assembly 210.

The color filter panel 212 may be provided with a color filter array, for example, red/green/blue color filters, formed as a thin film on a substrate made of transparent material such as glass or plastic or the like. Here, an upper polarizer is disposed on the outer surface of the color filter panel 212.

The TFT panel 214 is electrically connected via a driving film 216 to a printed circuit board 218 where a plurality of circuit components is mounted. The TFT panel 214 applies driving voltages supplied from the printed circuit board 218 to the LC layer in response to driving signals provided from the printed circuit board 218.

The TFT panel 214 is provided with TFTs and pixel electrodes formed as a thin film on a substrate made of a transparent material such as glass or plastic or the like. Here, a lower polarizer may be attached to the outer surface of the TFT panel 214.

The display device for displaying images has been described by exemplifying the TFT type LC panel assembly; however, this document is applicable to the OLEDs, the PDPs, the FEDs, CRTs, and so on, as well as the TFT type LC panel assembly.

In the LCD 100 according to the embodiment of this document, a user sees images displayed on the LC panel assembly 210 and touches a screen displaying desired information so as to input the information.

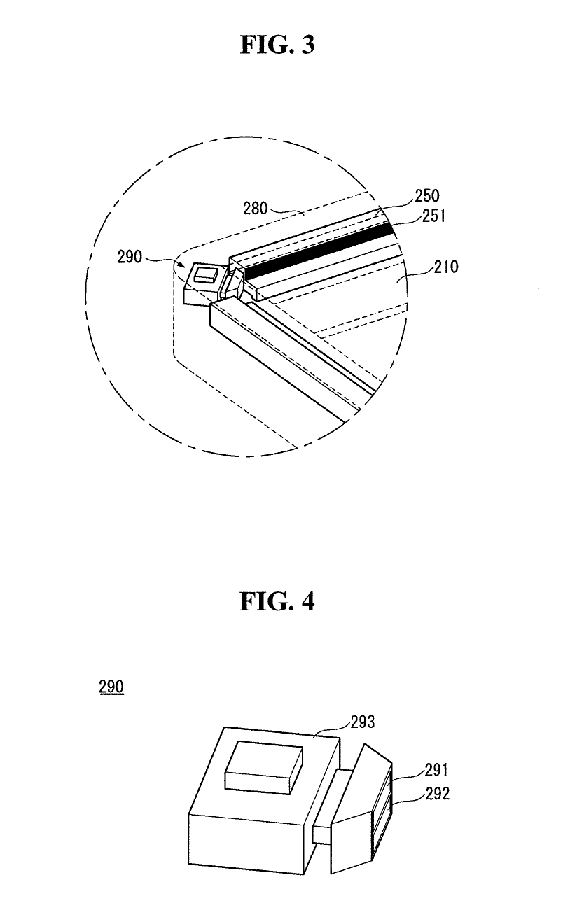

FIG. 3 is a perspective view illustrating a corner of the LCD 100 according to an embodiment of the invention. In this figure, the top case is marked with the dotted line, and the optical sensor and the reflector frame are marked with the solid line.

Referring to FIGS. 1 to 3, as a configuration for recognizing a position touched by a user, there are provided the reflector frames 250 having the reflectors 251, the top case 280 which couples the LC panel assembly 210 to the reflector frames 250, and the optical sensor camera 290 placed in at least one corner of the top case 280.

The reflector frame 250 has no corners and be placed in the periphery of the LC panel assembly 210. The reflector frame 250 is divided in plurality to be spaced apart from each other and placed in four edges of the LC panel assembly 210. Further, the reflector frame 250 is placed between the LC panel assembly 210 and the top case 280.

Such a reflector frame 250 substantially has a bar shape close to a rectangular parallelepiped shape, and is about 2 mm wide and about 10 mm high. The size varies depending on the size of the LCD, but, not limited thereto.

The width and the height of the reflector frame 250 are varied depending on the size of the optical sensor camera 290 which emits infrared rays.

The reflector frame 250 includes the reflector 251.

The reflector 251 reflects infrared rays emitted from the optical sensor camera 290, and is placed at a region in the reflector frame 250, which emits the infrared rays. In detail, for example, when the reflector frame 250 is divided in plurality, the reflector 251 is also divided in plurality, and, in this case, they may be disposed on surfaces where the respective reflector frames 250 face each other.

The reflector 251 is made of material reflecting infrared rays to reduce the loss of the infrared rays emitted from the optical sensor camera 290. For example, the reflector 251 may be formed by coating a metal such as Ag with a high reflectance on the region of the reflector frame 250, or by attaching reflection sheets made of Ag on the region of the reflector frame 250.

The optical sensor camera 290 is placed at the corner section of the reflector frame 250, that is, the inner side of the corner of the top case 280.

FIG. 4 is a diagram illustrating the optical sensor camera according to an embodiment of the invention.

Referring to FIG. 4, the optical sensor camera 290 has an infrared irradiation unit 291, an infrared incident unit 292, and an optical sensor driver 293.

The infrared irradiation unit 291 emits infrared rays to the upper side of the LC panel assembly LC panel assembly 210 in response to signals from the driver 293, and may be disposed in the diagonal direction of the LC panel assembly 210 so that the infrared rays are uniformly supplied to the upper side of the LC panel assembly 210.

The infrared incident unit 292 senses the infrared rays reflected from the reflector 251 of the reflector frame 250, and is placed in the lower part of the infrared irradiation unit 291. In the same manner as the infrared irradiation unit 291, the infrared incident unit 292 is disposed in the diagonal direction of the LC panel assembly 210 to maximally sense the infrared rays reflected from the reflectors 251.

The optical sensor driver 293 supplies signals for the infrared irradiation unit 291 to irradiate infrared rays, determines the infrared rays incident to the infrared incident unit 292 after reflection from the reflectors 251, and in turn analyzes a position touched by a user.

The optical sensor camera 290 is placed in at least one corner of the top case 280, and, for better sensing, may be placed in a diagonal corner of the top case 280 or all of the four corners.

A lens angle of view of each optical sensor camera 290 is about 90°. The lens angle of view of the optical sensor camera 290 may be varied depending on a distance between the LC panel assembly 210 and the optical sensor camera 290 or the size of the LC panel assembly 210. For example, the lens angle of view may be about 80° to 90°. This is because if the lens angle of view of the optical sensor camera 290 is less than 80°, the touch cannot be recognized accurately due to increasing blind zones, and if it is more than 90°, the touch cannot be recognized accurately due to including portions exceeding the LC panel assembly 210, either.

In the LCD 100, according to an embodiment of the invention, having the above-described configuration, a user sees a screen displayed on the LC panel assembly 210 and touches a section where desired information is displayed, and thus the optical sensor camera 290 detects the touch by the user.

More in detail, when infrared rays are emitted from the infrared irradiation unit 291 of the optical sensor camera 290 to the surface of the LC panel assembly 210, the infrared rays are reflected from the reflector of the reflector frame 250, and the reflected infrared rays are incident to the infrared incident unit 292 of the optical sensor camera 290. The optical sensor camera 290 detects whether or not there is a touch by comparing and determining the incident infrared rays.

If there is a touch by the user, after an angle of a picture image is converted, a section corresponding to the LC panel assembly 210, that is, a section touched by the user is detected to determine the touched position, by calculating a coordinate by the use of the triangulation method.

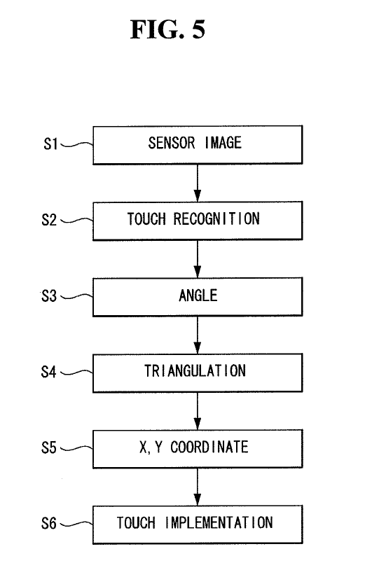

FIG. 5 is a flowchart illustrating control steps in a touch recognition algorithm according to an embodiment of the invention.

Referring to FIG. 5, the driver 293 of the optical sensor camera 290 receives one-dimensional images captured by the optical sensor camera 290, converts the one-dimensional images into binary data by the analog-digital conversion, and scans the binary data of the one-dimensional images to recognize the number and size of the touched objects (steps S1 and S2).

The driver 293 calculates angles between the optical sensor cameras 290 (if there are two or more cameras) and the touched objects (step S3). The angle θ formed by the touched object and the optical sensor camera 290 can be calculated, as shown in the following equation 1, by dividing a position P_{touch} of the touched object shown in the one-dimensional image captured by the optical sensor cameras 290, by a length L of the image, and by multiplying the value obtained by the division by the angle of view of the optical sensor (or viewing angle, θ_{view}).

$$θ = \frac{{P}_{touch}}{L} S {θ}_{view} \qquad Equation 1$$

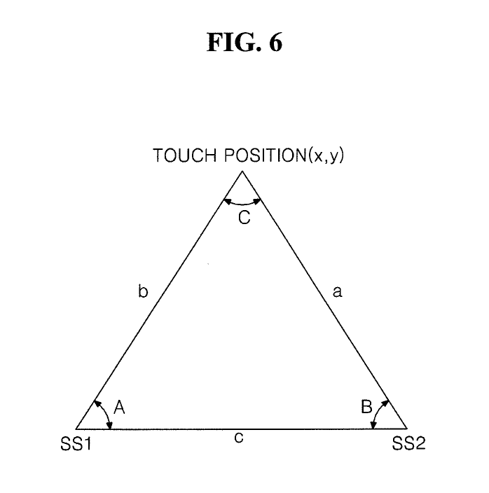

The driver 293 obtains xy coordinates for the respective touched points via the triangulation method using a trigonometrical function such as one shown in the following equation 2 (steps S4 and S5). Equation 2 is a calculation formula for obtaining an xy coordinate for each touched point, and, as shown in FIG. 6, it requires the optical sensor cameras SS1 and SS2, the respective angles A and B formed by the touched position and the optical sensor cameras SS1 and SS2, and the respective distances a, b and c between the touched position and the optical sensor cameras SS1 and SS2. The angle C formed by the touched position and the optical sensor cameras SS1 and SS2 is obtained by “C=180°−the angle A−the angle B.”

The driver 293 transmits a coordinate Txy for each touched position obtained by the triangulation method to a processing system to implement a touch function (step S6).

$$a = c * \frac{sin A}{sin C} \\ b = c * \frac{sin B}{sin C} \\ x = b * cos A \\ y = b * sin A \qquad Equation 2$$

The LCD 100 operated described above has the reflector frame and the optical sensor camera in the inner side of the top case.

In an LCD with a touch function as the related art, the touch function is implemented by covering tempered glass on a top case and then providing an optical sensor camera and a reflector frame on the tempered glass. In order to implement the touch function, the planarization in an area where the optical sensor camera and reflector frame are placed is very important, and the tempered glass played a part in the planarization in the related art. However, the tempered glass has drawbacks of being very thick, for example, 3 mm thick, heavy, and expensive.

The LCD according to an embodiment of the invention has advantages as described above. For Example, the planarization is achieved by increasing the thickness of the top case rather than the tempered glass and the manufacturing cost and weight can be reduced by providing the reflector frame 250 and optical sensor camera 290 inside the top case. Moreover, such a touch technique can be easily applied to large-sized display devices.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures. Moreover, unless the term “means” is explicitly recited in a limitation of the claims, such limitation is not intended to be interpreted under 35 USC 112(6).

What is claimed is:

1. A liquid crystal display, comprising:
a backlight unit;
a liquid crystal panel assembly placed on the backlight unit;
a reflector frame placed in the periphery of the liquid crystal panel assembly and including a reflector;
a top case coupling the backlight unit, the liquid crystal panel assembly, and the reflector frame to each other; and
an optical sensor camera placed in at least one corner of the top case.

2. The liquid crystal display of claim 1, wherein the reflector frame is divided in plurality to be spaced apart from each other and respectively placed in four edges of the liquid crystal panel assembly.

3. The liquid crystal display of claim 1, wherein the reflector is placed at surfaces where the reflector frames face each other.

4. The liquid crystal display of claim 1, wherein the reflector frame and the optical sensor camera are placed between the liquid crystal panel assembly and the top case.

5. The liquid crystal display of claim 4, wherein the reflector frame and the optical sensor camera are placed in the inner side of the top case.

6. The liquid crystal display of claim 1, wherein the optical sensor camera and the reflector frame are placed on the same plane.

7. The liquid crystal display of claim 1, wherein the optical sensor camera is equal to or more than one.

8. The liquid crystal display of claim 1, wherein the optical sensor camera comprises an infrared irradiation unit and an infrared incident unit.

9. The liquid crystal display of claim 1, wherein a lens angle of view of the optical sensor camera ranges from about 80° to about 90°.
